(19) United States
(12) Patent Application Publication
(10) Pub. No.: US 2019/0184689 A1
(43) Pub. Date: Jun. 20, 2019

(54) REUSABLE KITCHEN LABELS

(71) Applicant: Peter Maine Forhan, West Bloomfield, MI (US)

(72) Inventor: Peter Maine Forhan, West Bloomfield, MI (US)

(21) Appl. No.: 16/221,269

(22) Filed: Dec. 14, 2018

Related U.S. Application Data
(60) Provisional application No. 62/599,404, filed on Dec. 15, 2017.

(51) Int. Cl. B32B 27/30; B32B 27/32; B32B 27/08; C09J 7/24

(52) U.S. Cl. CPC B32B 27/308; B32B 27/304; B32B 27/32; B32B 27/08; B32B 2519/00; C09J 7/243; B32B 2307/412; B32B 2307/514; B32B 2307/7265; C09J 7/245

(57) ABSTRACT

The following label is usable in kitchen environments. The label has a reusable surface layer, a contrasting structural layer, and an adhesive layer for adhering to storage and serving containers, such as bins, buckets, and trays. The label materials are waterproof so that the label is erased but not removed by routine washing of the storage containers.

### CROSS REFERENCE TO RELATED APPLICATION

This application claims the benefit of U.S. Provisional Patent Application No. 62/599,404, which was filed on Dec. 15, 2017 and which is incorporated by reference herein for all purposes.

### FIELD OF THE DISCLOSURE

This disclosure relates to the field of container labeling, especially reusable labeling for kitchens and similar work environments.

### BACKGROUND OF THE INVENTION

Food service operations label their food bins and other storage contains, some for efficiency and many due to laws and regulations. Many labels, especially in the commercial kitchens, are single use and adhesive-backed materials that are designed to be affixed to metal or plastic surfaces on storage containers, such as bins, buckets, and trays. Due to the moisture in a kitchen environment, the containers are often made of rustproof or rust resistance materials that retain their structural integrity after washing, such as stainless steel and high density polyethylene (HDPE). The labels are often used to indicate changeable status information regarding the contents of the storage containers, such as expiration dates, contents, best use by dates, etc. Typically, an old label is removed and a new label is applied to a storage container whenever the information changes.

A shortcoming of the current labels is the need to remove the label and replace it when the contents of the storage container change. Another shortcoming is the residue of the adhesive which is commonly left on the surface of the storage container after incomplete removal of the label. The adhesive residue can make it difficult to apply a new label and provides a breeding ground for harmful bacteria on the surface of a container that is directly or indirectly involved with the preparation or consumption of food.

Another shortcoming of the present labels is the amount of waste produced by the time it takes for workers to apply and remove the labels on the storage containers. Proper application of a label to a storage container takes time to avoid wrinkling and ensuring uniform contact between the label and the container surface. Removal can be difficult, especially when labels tear and leave part of the label remaining on the container. Then, the adhesive residue from the removed portion of a label may adhere to the gloves of the workers, requiring additional clean up and adding further risk of contamination of any bacteria growing on the adhesive residue. Then there is the amount of waste paper/plastic produced as the single-use labels are discarded after a very short use life.

What is needed is a kitchen suitable label that can be reused to reduce the number of application/removal occurrences and the associated time and work. What is also needed is a kitchen suitable label that can reduce contamination risk and discard waste.

### BRIEF SUMMARY OF THE DISCLOSURE

In aspects, the present disclosure is related to food and storage container labeling, especially labeling with a reusable writing surface.

One embodiment according to the present disclosure includes a label including a first layer that is transparent and configured to receive ink markings; a second layer that is flexible, waterproof, and configured to support the first layer; and a third layer comprising a waterproof adhesive and disposed on the second layer opposite the first layer. In some alternative embodiments, the first layer may be opaque. The first layer may include polypropylene. The polypropylene may be oriented polypropylene. The second layer may include a mixture of polyethylene and polypropylene or polyvinylchloride. The second layer may be made of synthetic paper. The third layer may include an adhesive acrylic blend, an adhesive rubber/acrylic blend, or a synthetic resin. The third layer may include a perimeter of excess adhesive proximate to the perimeter of the second layer.

Another embodiment according to the present disclosure includes a method of applying a label with an excess adhesive proximate to its perimeter. The method includes applying force to the center of the label make contact with a surface; and spreading the force between the label and the surface outward from the center of the label to force the excess adhesive to form an outside adhesive perimeter around the label.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

A better understanding of the present disclosure can be obtained with the following detailed descriptions of the various disclosed embodiments in the drawings, which are given by way of illustration only, and thus are not limiting the present disclosure, and wherein:

FIG. 1 is a diagram a storage container with a partially removed prior art label;

FIG. 2 is an exploded diagram of a reusable label according to one embodiment of the present disclosure;

FIG. 3A is a diagram of a perimeter adhesive pattern on the back of the second layer of the label of FIG. 2;

FIG. 3B is a diagram of the adhesive (third) layer on the back the second layer of the label of FIG. 2;

FIG. 4 is diagram of the label of FIG. 2 in situ on a storage container according to one embodiment of the present disclosure; and

FIG. 5 is side view diagram of the label and container of FIG. 4;

FIG. 6 is flow chart of a method for applying the label of FIG. 2 to a container according to one embodiment of the present disclosure.

### DETAILED DESCRIPTION OF THE DISCLOSURE

In aspects, the present disclosure is related to labeling of containers. Specifically, the present disclosure is related to labels for use in a kitchen or other food handling environment where label informational content is frequently changed.

The present invention is susceptible to embodiments of different forms. There are shown in the drawings, and herein will be described in detail, specific embodiments with the understanding that the present invention is to be considered an exemplification of the principles and is not intended to limit the present invention to that illustrated and described herein.

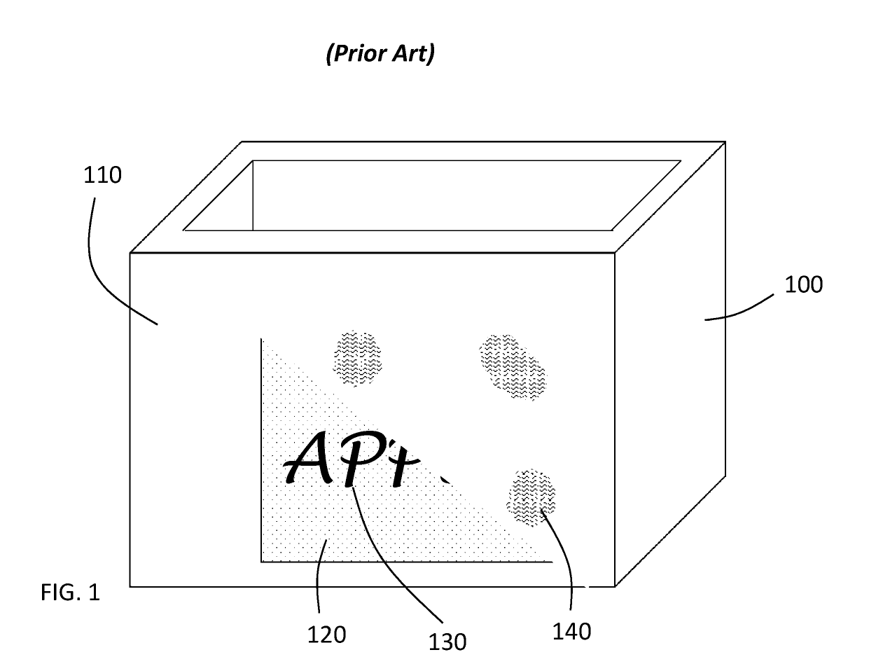

FIG. 1 shows a diagram of a prior art storage container 100 with partially removed label 120 on a storage container's surface 110. The partial label 120 shows written text 130 and has left behind adhesive residue 140 on the surface 110.

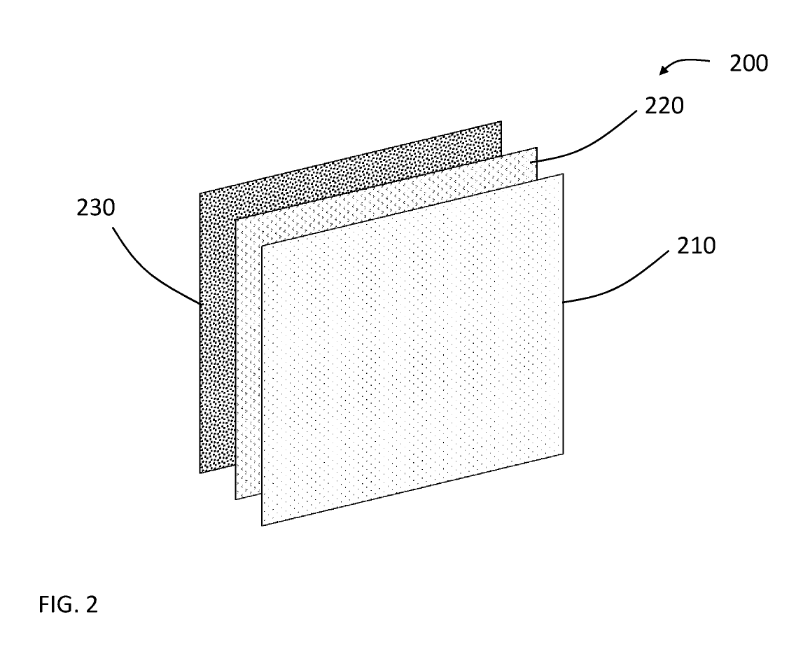

FIG. 2 shows an exploded diagram of a reusable label 200. The label 200 includes an information layer 210, a structural layer 220, and an adhesive layer 230, referred to throughout as the first, second, and third layers, respectively. The reusable nature of the label 200 is found in the first layer 210, which is erasable, and, thus, may be reused to identify different contents of whatever container to which the label 200 is attached. The first layer 210 is waterproof but capable of receiving ink, such as that found in dry erase and permanent markers. Additionally, ink that does not smear under water based stress often found in kitchens, such as steam, condensation, and water baths, may also be used. The first layer 210 may be made of a polypropylene film. Additionally, laminates, acrylic coatings, polyester coatings may be used as alternatives to the polypropylene film. In some embodiments, the polypropylene film is an oriented polypropylene film. The first layer 210 provides a smooth surface that can be written on by an erasable marker and later erased without absorbing any of the ink from marker. Thus, the first layer 210 can be marked, washed by hand or a conventional dishwashing machine, and then reused. The second layer 220 provides structural support for the first layer 210. The second layer 220 may be colored to have a strong contrast with an ink intended for application to the first layer 210. For example, the second layer 220 may be white in color to contrast with a black ink marker applied to the first layer 210. The second layer 220 may be waterproof and. In some embodiments, the second layer 220 may be made of a synthetic paper. In some embodiments, the second layer may include a mixture of polypropylene and polyethylene. In some embodiments, the second layer may include polyvinylchloride or polystyrene. The thickness of the second layer 220 may be varied to control the stiffness of the label 200 as would be understood by a person of skill in the art. In some embodiments, non-erasable indicia may be applied to the second layer 220 that will be visible through the first layer 210. In other embodiments, non-erasable indicia may be applied to the first layer 210. The second layer 220 may be tear-resistant, resilient, and not subject to significant dimensional changes due to changes in temperature over a temperature range of about −18 degrees Celsius to about 150 degrees Celsius. In some embodiments, the second layer 220 may have thermal expansion properties selected based on the surface to which the label 200 is to be applied. For example, in an embodiment where the label 200 is designed for application to an HDPE container, the second layer 220 be made of a material with thermal expansion characteristics that are the same or similar to those of HDPE. The similar thermal expansion characteristics of the second layer 220 and the container 100 will reduce the stress between the label 200 and the container 100 that can weaken the adhesive bond between the label 200 and the surface 110. In some embodiments, the second layer 220 may be made of a thinner version of the same material as the container 100. A third layer 230 is made of an adhesive for attaching the label 200 to the surface 110 of the container 100. The adhesive is waterproof and nontoxic at temperatures between −18 degrees Celsius and 150 degrees Celsius. Suitable adhesives may include, but are not limited to an adhesive acrylic blend, an adhesive rubber/acrylic blend, or a synthetic resin.

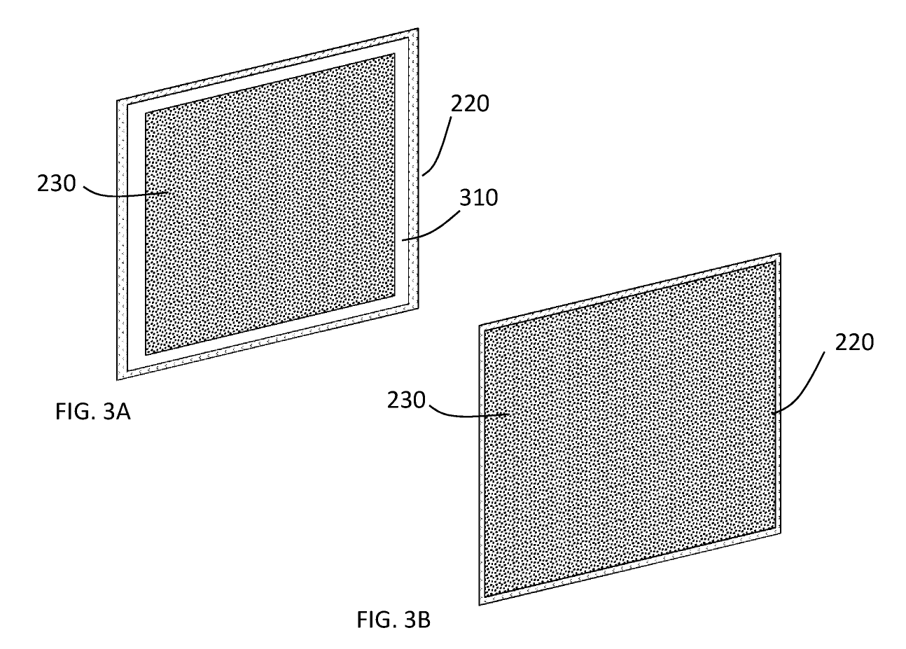

FIG. 3A shows a diagram of the second layer 220 and the third layer 230 viewed with the third layer 230 in the foreground. The third layer 230 may include an adhesive perimeter region 310, which is a thickened amount of the same adhesive used throughout the third layer 230. When the label 200 is applied to the container surface 110, the excess adhesive in the adhesive perimeter region 310 is squeezed out toward the ends of the second layer 220. This excess adhesive may extend beyond the perimeter of the second layer 220 and form a seal (e.g. water lock) to prevent water or other liquids from getting between the label 200 and the container surface 110. The excess adhesive extending beyond the perimeter of the second layer 220 may increase adhesion strength and reduce the risk of bacterial growth. FIG. 3B shows a diagram of the second layer 220 and the third layer 230 viewed with the third layer 230 in the foreground but without the adhesive perimeter region 310. While FIG. 3B shows the third layer 230 as not coterminous with the perimeter of the second layer 220, this is exemplary and illustrative only, and the coterminous second and third layers 220, 230 are contemplated.

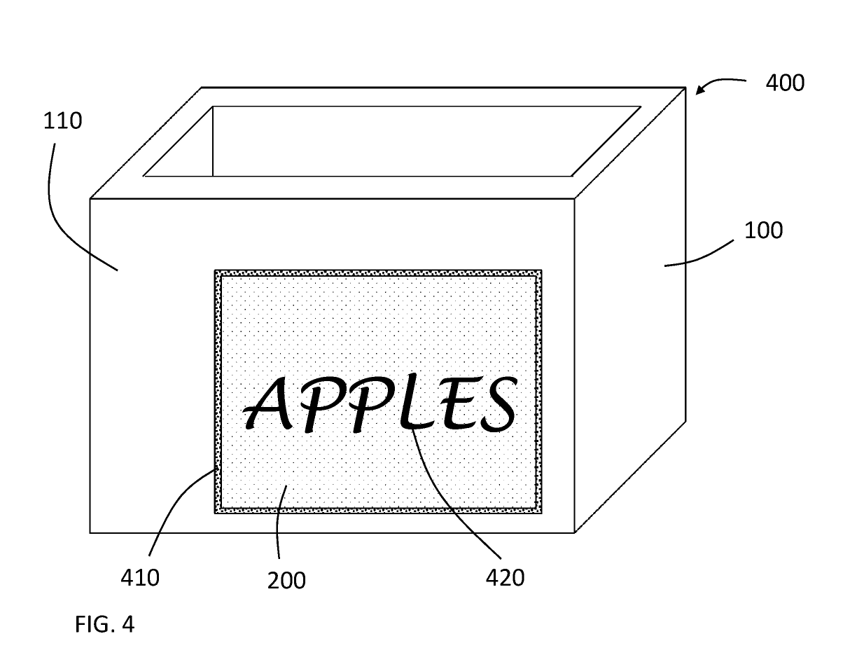

FIG. 4 shows a diagram of a labeled storage container 400 with the label 200 affixed to the surface 110 of the storage container 100. The adhesive from the perimeter ring 310 has been squeezed out to form an outside perimeter of adhesive 410 around the label 200. The marker inked words 420 are shown on the label 200.

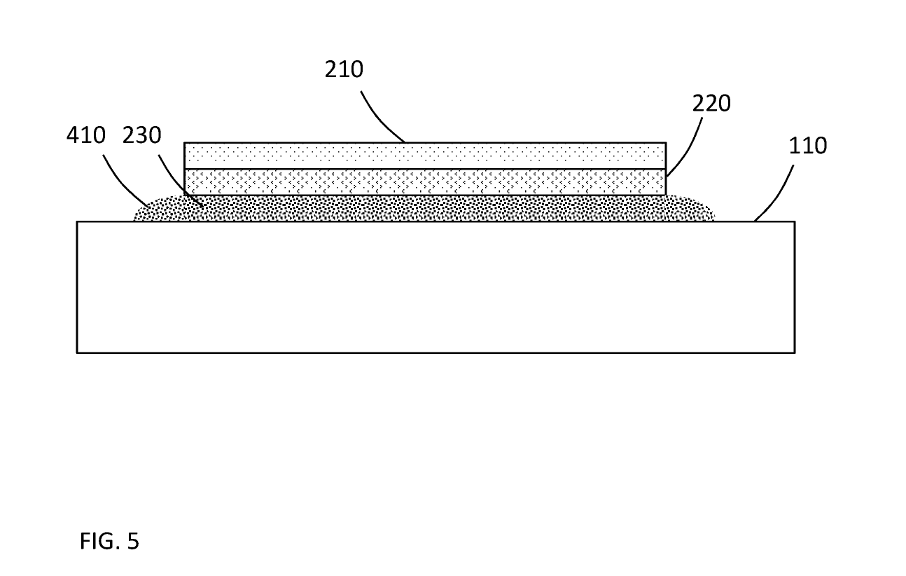

FIG. 5 shows a side view of the applied label 200 in FIG. 4. The outside adhesive perimeter 410 is shown to extend past the edge of the second layer 220. The extension distance beyond the edge of the second layer 220 may be varied based on the amount and type of adhesive used and the material properties of the surface 110. By providing a gradual, sloped adhesive edge rather than a sharp cutoff, such as the adhesive layer 230 being coterminous with the second layer 220 at the perimeter, the adhesion strength is increased due to the reduction in the size of the “crack” or division between the label 200 and the surface 110. Thus, stress concentrators are reduced or eliminated.

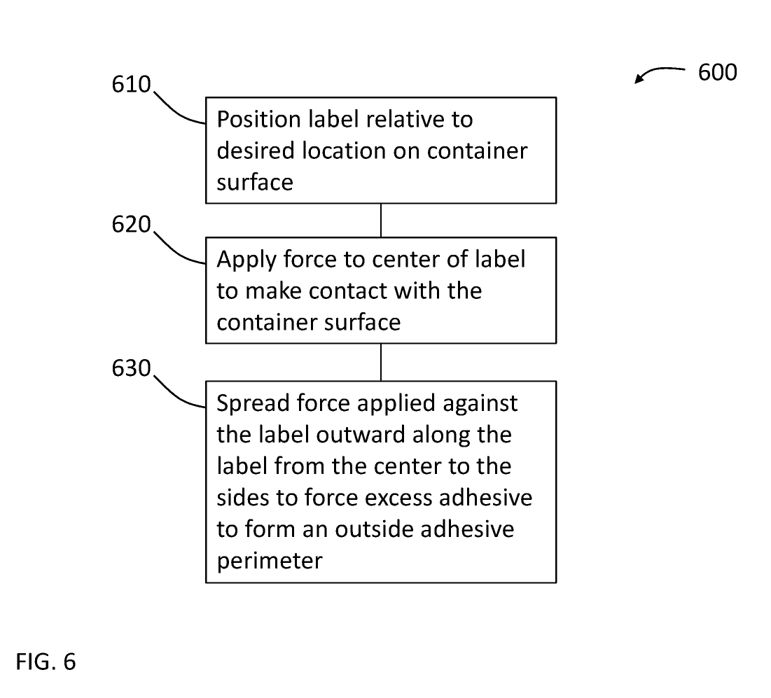

FIG. 6 shows a flow chart of a method 600 for applying the label 200 to the surface 110. In step 610, the label is positioned over surface of container at a desired location. In step 620, force is applied to the center of label to place the label in contact with the container surface 110. In step 630, force is applied against the label and spreading outward from the center to the sides of the label to ensure contact and to force the excess adhesive in the adhesive perimeter region 310 to flow out from the sides of the label and to form the outer adhesive perimeter 410.

While embodiments in the present disclosure have been described in some detail, according to the preferred embodiments illustrated above, it is not meant to be limiting to modifications such as would be obvious to those skilled in the art.

The foregoing disclosure and description of the disclosure are illustrative and explanatory thereof, and various changes in the details of the illustrated apparatus and system, and the construction and the method of operation may be made without departing from the spirit of the disclosure.

What is claimed is:

1. A label comprising,
a first layer that is configured to receive ink markings;
a second layer that is flexible, waterproof, and configured to support the first layer; and
a third layer comprising a waterproof adhesive and disposed on the second layer opposite the first layer.

2. The label of claim 1, wherein the first layer comprises polypropylene.

3. The label of claim 1, wherein the first layer is transparent.

4. The label of claim 2, wherein the polypropylene is oriented polypropylene.

5. The label of claim 1, wherein the second layer comprises a mixture of polyethylene and polypropylene.

6. The label of claim 1, wherein the second layer comprises polyvinylchloride.

7. The label of claim 1, wherein the second layer comprises synthetic paper.

8. The label of claim 1, wherein the waterproof adhesive comprises an acrylic blend.

9. The label of claim 1, wherein the third layer includes a perimeter of excess adhesive proximate to the perimeter of the second layer.

10. A method of applying a label with an excess adhesive proximate to its perimeter, the method comprising:
applying force to the center of the label make contact with a surface; and
spreading the force between the label and the surface outward from the center of the label to force the excess adhesive to form an outside adhesive perimeter around the label.
